(19) United States
(12) Patent Application Publication
(10) Pub. No.: US 2010/0236081 A1
(43) Pub. Date: Sep. 23, 2010

(54) Tree pruner

(76) Inventor: Wen-Li Guo, Zhangzhou City (CN)

Correspondence Address: CHARLES E. BAXLEY, ESQUIRE, 90 JOHN STREET, SUITE 309, NEW YORK, NY, 10038, US

(21) Appl. No.: 12/583,880

(22) Filed: Aug. 27, 2009

(30) Foreign Application Priority Data
Mar. 18, 2009 (CN) 200920137227.5

(51) Int. Cl. A01G 3/08; B26B 13/26

(52) U.S. Cl. 30/249; 30/279.2

(57) ABSTRACT

A tree pruner includes a hook set, a blade pivotally mounted on the hook set, a main linkage pivotally connected to the hook set, an auxiliary linkage set pivotally connected to the main linkage and the blade, a first pulley mounted to the main linkage, a second pulley mounted to the hook set and a rope coiling the two pulleys. The auxiliary linkage set has a first linkage and a second linkage pivotally connected to each other for elongating a lever arm from the main linkage.

### BACKGROUND OF THE INVENTION

1. Field of the Invention

The present invention relates to a garden tool, and more particularly to a tree pruner for pruning the branches of a tree.

2. Description of Related Art

A conventional tree pruner in accordance with the prior art shown in FIG. 1 only uses the simple lever principle and comprises a hook set (10), a blade (20) pivotally disposed on the hook set (10), a main linkage (30) pivotally connected to the hook set (10), an auxiliary linkage (40) pivotally connected to the blade (20) and the main linkage (30), a first pulley (50) mounted to a free end of the main linkage (30), a second pulley (50′) is mounted to a lower portion of the hook set (10) and a rope (60) having one end sequentially coiling the first pullet (50) and the second pulley (50′), and finally secured on the first pulley (50).

A hook (101) is formed on a top portion of the hook set (10) for hooking the tree branch (70). A first cutting edge (102) is formed on an inner edge of the hook (101). The middle of the blade (20) is pivotally mounted to the hook (101) by a pivot (201). A second cutting edge (202) is formed on a lower edge of the blade (20) and corresponds to the first cutting edge (102). The auxiliary linkage (40) having a first end pivotally connected to a upper portion of the blade (20) by a first pivot (401) and a second end pivotally connected to a middle portion of the main linkage (30) by a second pivot (402). The main linkage (30) has one end, opposite to the first pulley (50), pivotally connected to a middle portion of the hook set (10) by a third pivot (301).

With reference to FIG. 2, when operating the tree pruner in accordance with the prior art, the hook set (10) is held and the hook (101) hooks the tree branch (70). The main linkage (30) is wiggled relative to the third pivot (301) to make the blade (20) wiggled relative to the pivot (201) via the auxiliary linkage (40) when the rope (60) is downward pulled. At the same time, the second cutting edge (202) of the blade (20) is moved toward the first cutting edge (102) of the hook (101) to cut off the tree branch (70) within the hook (101).

As described above, the blade (20) is driven by the main linkage (30) via the auxiliary linkage (40). However, the main linkage (30) has a small lever arm. Accordingly, the moment from the main linkage (30) is small due to a same force. Consequently, the conventional tree pruner is suitable to a tree branch that has a diameter under 3 millimeter. A saw is necessary when the diameter of the tree branch is greater than 3 millimeter. However, a saw is hard to be highly operated. It is very inconvenient.

The present invention has arisen to mitigate and/or obviate the disadvantages of the conventional tree pruner.

### SUMMARY OF THE INVENTION

The main objective of the present invention is to provide an improved tree pruner that provides a great moment and is provided for the tree branch that has a diameter about 5 millimeter.

To achieve the objective, the tree pruner in accordance with the present invention comprises a hook set having a hook formed on a top portion thereof for hooking a tree branch and a first cutting edge formed on an inner edge of the hook. A blade has a middle portion pivotally mounted to the hook. A second cutting edge is formed on a first end of the blade and corresponds to the first cutting edge. A main linkage has a first end pivotally connected to a middle portion of the hook set. An auxiliary linkage set is pivotally connected to the main linkage and the blade. The auxiliary linkage set includes a first linkage having a first end pivotally connected to a middle portion of the main linkage and a second linkage having a first end pivotally connected to a second end of the first linkage. The blade has a second end pivotally connected to a middle portion of the second linkage such that the second linkage can provide a stable and exact transmission. A first pulley is mounted to a second end of the main linkage. A second pulley is mounted to a lower portion of the hook set. A rope has a first end secured on the first pulley after sequentially coiling the first pulley and the second pulley, and a second end for user to drive the main linkage.

Further benefits and advantages of the present invention will become apparent after a careful reading of the detailed description with appropriate reference to the accompanying drawings.

### BRIEF DESCRIPTION OF THE DRAWINGS

FIG. 1 is a side plan view of a conventional tree pruner in accordance with the prior art;

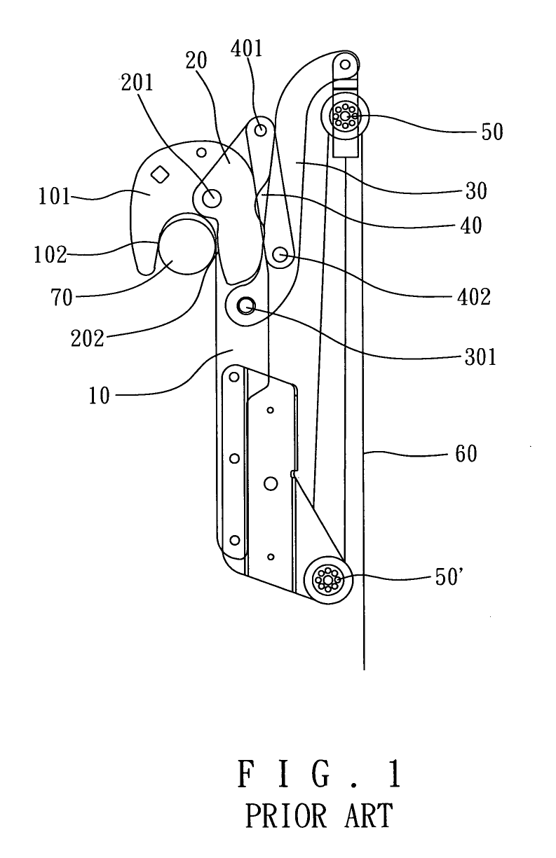

FIG. 2 is an operational view of the tree pruner in FIG. 1;

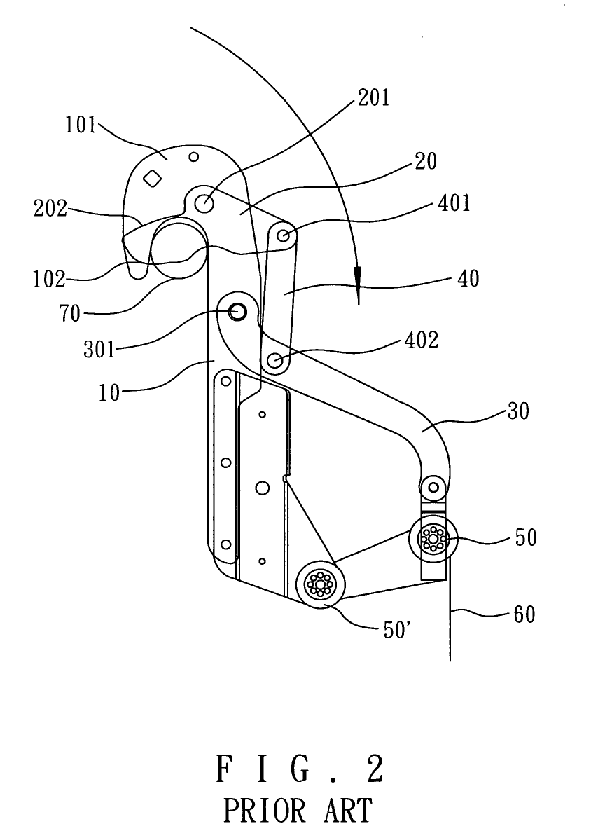

FIG. 3 is a side plan view of a tree pruner in accordance with the present invention; and

FIG. 4 is an operational view of the tree pruner in FIG. 3.

### DETAILED DESCRIPTION OF THE INVENTION

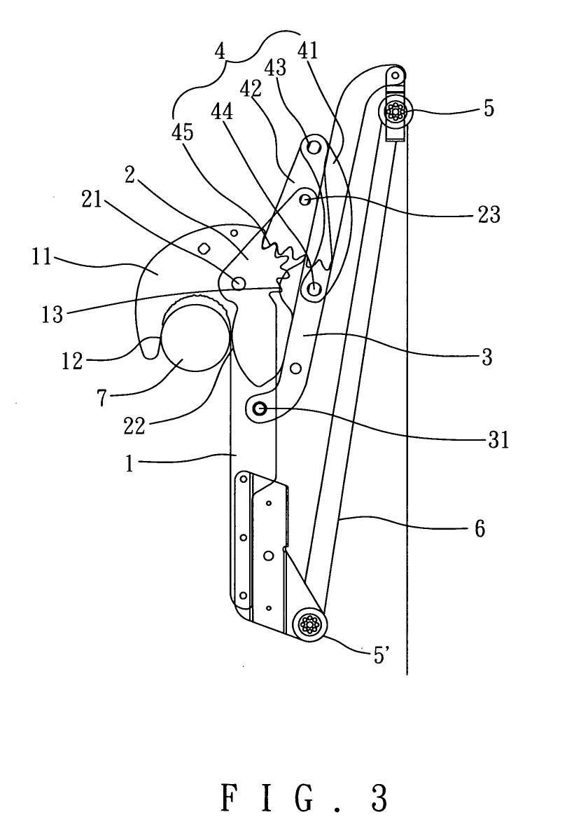

Referring to the drawings and initially to FIG. 3, a tree pruner in accordance with the present invention comprises a hook set (1), a blade (2) pivotally mounted on the hook set (1), a main linkage (3) pivotally connected to the hook set (1), an auxiliary linkage set (4) pivotally connected to the main linkage (3) and the blade (2), a first pulley (5) mounted to the main linkage (3), a second pulley (5′) mounted to the hook set (1) and a rope (6) coiling the two pulleys (5, 5′).

The hook set (1) has a hook (11) formed on a top portion thereof for hooking the tree branch and a first cutting edge (12) is formed on an inner edge of the hook (11).

The blade (2) has a middle portion pivotally mounted to the hook (11) by a first pivot (21). A second cutting edge (22) is formed on a first end of the blade (2) and corresponds to the first cutting edge (12).

The main linkage (3) has a first end pivotally connected to a middle portion of the hook set (1) by a second pivot (31).

The first pulley (5) is mounted to a second end of the main linkage (3) and the second pulley (5′) is mounted to a lower portion of the hook set (1).

The rope (6) has a first end sequentially coiling the first pulley (5) and the second pulley (5′). Finally, the first end of the rope (6) is secured on the first pulley (5). The rope (6) has a second end for user to pull and operate the tree pruner.

The auxiliary linkage set (4) includes a first linkage (41) having a first end pivotally connected to a middle portion of the main linkage (3) by a third pivot (44) and a second linkage (42) having a first end pivotally connected to a second end of the first linkage (41) by a fourth pivot (43). The blade (2) has a second end pivotally connected to a middle portion of the second linkage (42) by a fifth pivot (23) such that the second linkage (42) can provide a stable and exact transmission. A first series of teeth (13) is formed on an outer periphery of the hook (11) and a second series of teeth (45) is formed on a second end of the second linkage (42), wherein the first series of teeth (13) and the second series of teeth (45) are engaged to each other.

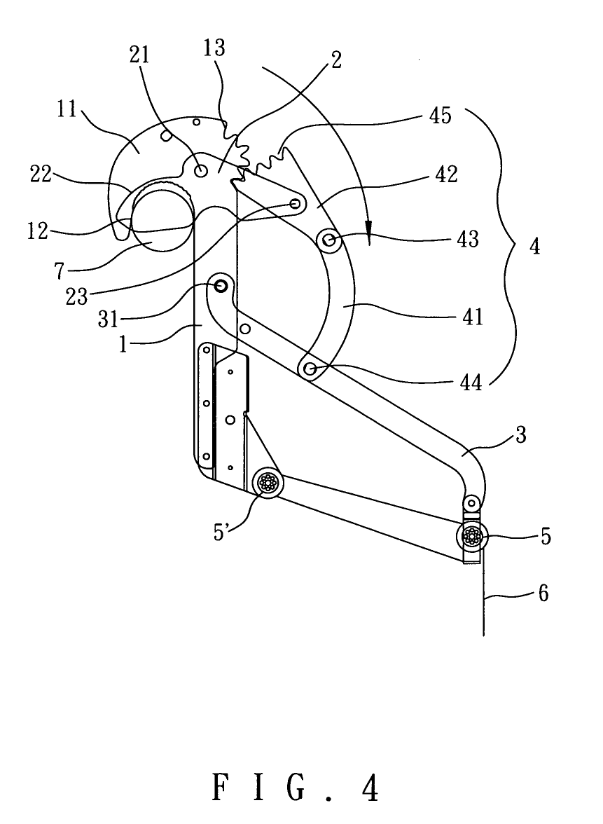

With reference to FIG. 4, when operating the tree pruner in accordance with the present invention, the hook set (1) is held to make the hook (11) hooking the tree branch (7) and the rope (6) is downward pulled. The main linkage (3) is wiggled relative to the second pivot (31) to make the first linkage (41) being wiggled relative to the third pivot (44). Sequentially, the first linkage (41) drives the second linkage (42) and the second linkage (42) drives the blade (2) to make the second cutting edge (22) moved toward the first cutting edge (12) to cut off the tree branch (7) within the hook (11). The engaged first series of teeth (13) and the second series of teeth (45) can ensure that the second linkage (42) is moved along an exact track. In the transmitting processes, the lever arm of the main linkage (3) is elongated due to the first linkage (41) and the second linkage (42) that are pivotally connected to each other such that the moment from the main linkage (3) is enlarged when the rope (6) is downward pulled. As a result, the tree pruner in accordance with the present invention can be provided for a tree branch that a diameter about 5 millimeter. The tree pruner in accordance is more effort-saving relative to the conventional tree pruner in accordance with the prior art.

Although the invention has been explained in relation to its preferred embodiment, it is to be understood that many other possible modifications and variations can be made without departing from the spirit and scope of the invention as hereinafter claimed.

What is claimed is:

1. A tree pruner comprising:
a hook set having a hook formed on a top portion thereof for hooking a tree branch and a first cutting edge formed on an inner edge of the hook;
a blade having a middle portion pivotally mounted to the hook, a second cutting edge formed on a first end of the blade and corresponding to the first cutting edge;
a main linkage having a first end pivotally connected to a middle portion of the hook set;
an auxiliary linkage set pivotally connected to the main linkage and the blade, the auxiliary linkage set including a first linkage having a first end pivotally connected to a middle portion of the main linkage and a second linkage having a first end pivotally connected to a second end of the first linkage, the blade having a second end pivotally connected to a middle portion of the second linkage such that the second linkage can provide a stable and exact transmission;
a first pulley mounted to a second end of the main linkage;
a second pulley mounted to a lower portion of the hook set; and
a rope having a first end secured on the first pulley after sequentially coiling the first pulley and the second pulley, and a second end for user to drive the main linkage.

2. The tree pruner as claimed in claim 1, wherein the hook includes a first series of teeth formed on an outer periphery thereof and the second linkage includes a second series of teeth formed on a second end thereof, the first series of teeth and the second series of teeth engaged to each other for ensuring that the second linkage (42) is moved along an exact track.
